(19) United States
(12) Patent Application Publication
(10) Pub. No.: US 2006/0222233 A1
(43) Pub. Date: Oct. 5, 2006

(54) Pattern defect inspection method and apparatus using image correction technique

(75) Inventors: Shinji Sugihara, Tokyo (JP); Junji Oaki, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc., Kawasaki-shi (JP)

(21) Appl. No.: 11/386,744

(22) Filed: Mar. 23, 2006

(30) Foreign Application Priority Data
Mar. 29, 2005 (JP) 2005-095464

(51) Int. Cl. G06K 9/00

(52) U.S. Cl. 382/144

(57) ABSTRACT

An image correction method employable in a pattern inspection method for emitting light falling onto a workpiece with a pattern formed thereon and for inspecting a pattern image resulting from the pickup of an optical image of the workpiece by comparing it to a corresponding fiducial pattern image is disclosed. The method includes the step of generating a system of equations describing therein an input/output relation using a 2D linear prediction model(s) with respect to the pattern image being tested and the fiducial pattern image. Then, estimate the equation system by least-squares methods to thereby obtain a parameter of the equation system. Next obtain a centroid of the parameter. Then perform interpolation using the value of the centroid, thereby to generate a corrected image. A pattern defect inspection method using the image correction method is also disclosed.

### CROSS-REFERENCE TO RELATED APPLICATION(S)

This application is based on and claims priority of Japanese Patent Application (JPA) No. 2005-095464, filed on Mar. 29, 2005, the disclosure of which is incorporated herein by reference.

### FIELD OF THE INVENTION

The present invention relates generally to pattern inspection techniques for inspecting an object for pattern defects and, more particularly, to a pattern defect inspection method of checking defects of a lithography mask employable in the manufacture of semiconductor devices and liquid crystal display (LCD) panels. This invention related to an image correction apparatus. This invention also relates to an image correction method adaptable for use in the pattern inspection method.

### DESCRIPTION OF RELATED ART

Yield advancement is inevitable for fabrication of large-scale integrated (LSI) circuit devices, which require increased manufacturing costs. One of factors which lower production yield is the presence of pattern defects in lithography-use photomasks, which are typically used when transferring an ultrafine circuit pattern onto semiconductor wafers. In recent years, with miniaturization or down-scaling of LSI patterns to be formed semiconductor wafers, defects to be detected become finer in minimum feature size accordingly. This defect miniaturization raises a need to further increase the accuracy of pattern inspection apparatus which inspects for defects a pattern transfer-use mask as used in the manufacture of LSI chips.

Prior known pattern inspection tools are usually designed to perform inspection by using a magnifying optical lens assembly to sense or capture at a prespecified magnification the circuit pattern that is formed on a workpiece, such as a lithography mask, and then comparing this captured image to either design data or a sensed image of an identical pattern at a different location on the same workpiece. A pattern inspection apparatus of this type is disclosed, for example, in Published Unexamined Japanese Patent Application No. 8-76359. In the apparatus as taught thereby, a workpiece to be tested is loaded and mounted on a movable stage structure. While this stage is driven to move, a beam of light scans the surface of workpiece so that pattern inspection is performed. The light falling onto the workpiece is emitted by a light source and guided by an illumination optical system. Light that passed through the workpiece or was reflected therefrom is then focused onto a sensor via the optics. An optical image as picked up by the sensor is sent forth to a comparator circuit in the form of an electrical measurement data signal. This comparator is operable to compare, after position alignment between images, the measurement data to reference data in accordance with an appropriate algorithm. If these fail to be coincide with each other, then determine pattern defects must be present.

In the pattern inspection, it is a must to retain the accuracy or precision as high as possible during the position alignment between those images represented by the measured data and the reference data.

One known approach to calculating a position correction quantity is to perform comparison between a couple of images while at the same time causing one of them to move or “shift” relative to the other. In this event a method is employed for performing image shifting while causing the image to shift in very short and typically uniform movements, thereby to finally obtain an optimal shift amount which minimizes a difference in position between the images being compared. An example of such shift amount is a value that minimizes a total square sum of a difference in gray-scale gradation or “tone” between the images of interest. Unfortunately, this method requires consumption of an increased length of exploring time if the step-like movements or shifts are lessened in the minimum unit thereof and thus is encountered with a problem as to limits in attainable accuracy.

Another problem in the prior art is an increase in apparatus manufacturing costs occurring due to increases in total amount of arithmetical computation required. The calculation amount increase would arise in the case of simultaneous inspection of a transmitted light image and a reflected light image of the pattern image of a workpiece being tested. This can be said because applying position correction to both of the transmitted and reflected images results in the total calculation amount being increased.

### BRIEF SUMMARY OF THE INVENTION

This invention has been made in view of the problems in the prior art, and an object of the invention is to provide a method for achieving in a simplified way the comparison required for mask pattern defect detection between a to-be-inspected pattern image represented by measurement image data and a fiducial pattern image indicated by reference image data while obtaining an alignment shift amount with increased accuracy to thereby enable position adjustment between the images. It is another object of the invention to provide a method of performing high-accuracy position correction or compensation of a transmission light image and reflection image of a workpiece being tested. It is a further object is to provide a high-reliability pattern defect inspection method using the position correction technique.

In accordance with one aspect of the invention, there is provided an image correction method for use in a pattern inspection method having the steps of emitting light falling onto a workpiece with a pattern formed thereon and inspecting a pattern image resulting from pickup of an optical image of the workpiece by comparing the pattern image to a corresponding inspection fiducial pattern image. The image correction method includes the steps of generating a set of equations which describe therein an input/output relation using a two-dimensional (“2D”) linear prediction model with respect to the pattern image being tested and the fiducial pattern image, estimating the equation set describing the input/output relation by a least-squares method to thereby obtain a parameter of the equation set, obtaining a centroid position of the parameter, and performing interpolation using a value of the centroid position to thereby generate a corrected image.

In accordance with another aspect of the invention, an image correction method which is used in the pattern inspection method includes generating a system of equations describing therein an input/output relation using a 2D linear prediction model with respect to any one of the test pattern images based on the transmission light and the reflection light and its corresponding inspection fiducial pattern image, estimating by a least-squares technique the equation system describing the input/output relation to thereby obtain more than one parameter of the equation system, using the parameter to combine together an estimation model image and the aforesaid any one of the test pattern images, obtaining a centroid of the parameter, adding to the centroid a predefined offset value to thereby provide an added centroid position value, and using this value to apply interpolation to a remaining one of the test pattern images which is out of the 2D linear prediction to thereby generate a corrected image.

In accordance with a further aspect of the invention, a pattern inspection method is provided for emitting light falling onto a workpiece with a pattern formed thereon and for inspecting a pattern image resulting from pickup of an optical image of the workpiece by comparing the pattern image to a corresponding inspection fiducial pattern image. This method includes generating a collection of equations describing therein an input/output relation using a 2D linear prediction model with respect to the pattern image being tested and the fiducial pattern image, estimating the equations describing the input/output relation by a least-squares technique to thereby obtain more than one parameter of the equations, obtaining a centroid position of the parameter, performing interpolation using a value of the centroid position to generate a corrected image, and comparing the corrected image to the fiducial pattern image.

In accordance with another further aspect of the invention, a pattern inspection method includes the steps of generating simultaneous equations describing therein an input/output relation using a 2D linear prediction model with respect to any one of the test pattern images due to the transmission light and the reflection light and its corresponding inspection fiducial pattern image, estimating by a least-squares method the simultaneous equations describing the input/output relation to thereby obtain more than one parameter of the equations, using this parameter to combine together an estimation model image and the above-noted one of the test pattern images, obtaining a centroid of the parameter, adding to the centroid a prespecified offset value to thereby provide an added centroid position value, using this value to apply interpolation to the remaining one of the test pattern images which is free from the 2D linear prediction, and comparing the corrected image to the fiducial pattern image.

In accordance with another further aspect of the invention, a pattern inspection apparatus for emitting light falling onto a workpiece with a pattern formed thereon and for performing pattern comparison inspection by use of a pattern image to be tested resulting from pickup of an optical image of the workpiece and an inspection fiducial pattern image corresponding thereto, comprising: first means for generating a set of simultaneous equations describing therein an input/output relation using a 2D linear prediction model with respect to the pattern image being tested and the fiducial pattern image; second means for estimating the equations describing the input/output relation by a least-squares technique to thereby obtain a parameter of said equations; third means for obtaining a centroid position of the parameter; fourth means for performing interpolation using a value of the centroid position to thereby generate a corrected image; and fifth means for comparing the corrected image to said fiducial pattern image.

According to the invention, it is possible to provide high-reliability pattern defect inspection methodology capable of performing position correction with increased accuracy.

### BRIEF DESCRIPTION OF THE DRAWINGS

FIG. 1 is a diagram showing a flow of a pattern image creation process employable in a mask pattern defect inspection method embodying the invention.

FIG. 2A is a pictorial representation of an exemplary fiducial pattern image for use during workpiece inspection; and FIG. 2B illustrates a pattern image to be inspected.

FIG. 3 depicts, in block diagram form, a configuration of a mask defect inspection apparatus adaptable for use with the method embodying the invention.

FIG. 4 shows a configuration of another mask defect inspection apparatus also embodying the invention. FIG. 5 is a process flow diagram of a mask pattern inspection method embodying the invention.

### DETAILED DESCRIPTION OF THE INVENTION

### First Embodiment

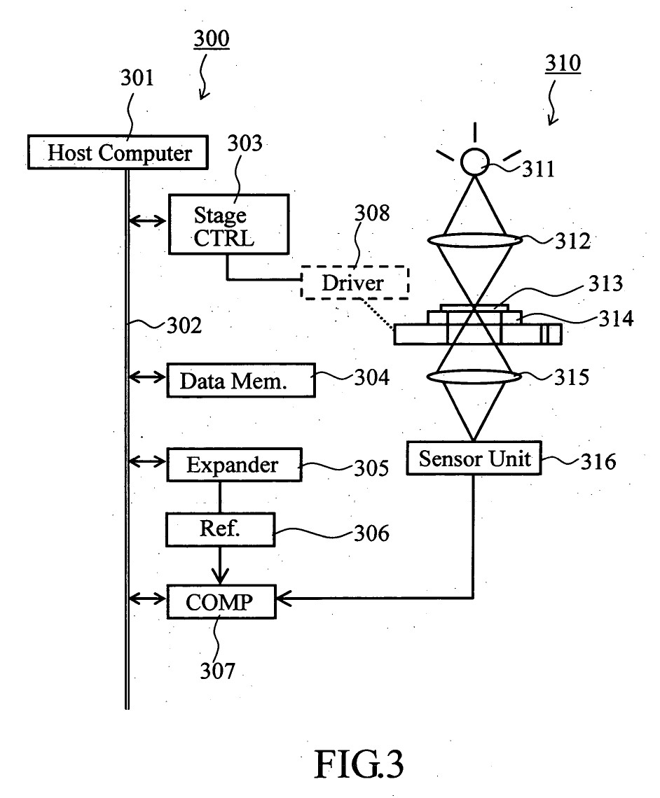

An explanation will be given of an embodiment which is arranged to develop an inspection-use fiducial or “base” pattern image from a database of design data of this pattern and compare it to the sensed pattern image of a workpiece being tested, thereby inspecting the workpiece for defects. FIG. 3 shows schematically a configuration of mask defect inspection apparatus suitable for use in this embodiment as will be described in detail below.

The mask defect inspection apparatus of FIG. 3 is generally made up of an arithmetic computation control unit 300 including a host computer as its major component, and an observational data generating unit 310 operable to sense an optical image of the circuit pattern of a workpiece—here, photomask.

The computation control unit 300 includes a host computer 301, a signal transmission path 302 which has a bundle of address and data buses connected to the host computer 301, a stage control circuit 303 coupled to the signal transfer path 302, a data storing memory 304, a data evolution/expansion circuit 305, a reference data generator circuit 306, and a comparison circuit 307.

The observation data generator unit 310 is configured from a light source 311 which emits illumination light, an illumination optical system 312 which collects together light rays from the light source 311 to cause a beam of light to fall onto a workpiece 313 under testing, a stage structure 314 which supports the workpiece 313 as mounted thereon, a magnifying optical lens assembly 315 for pickup of an optical image corresponding to the circuit pattern of the workpiece 313, and a sensor module 316 including a photosensor and electrical drive circuitry associated therewith. The stage 314 is driven by a drive unit 308 connected thereto. This driver 308 is operation-controlled by the above-stated stage control circuit 303.

An operation of the mask defect inspection apparatus embodying the invention is as follows. The workpiece 313, such as a mask, is automatically transported and loaded by an auto-loader mechanism (not shown) and is then mounted on the stage 314. After completion of defect checking, workpiece 313 is unloaded in an automated way.

The light rays leaving from the light source 311 that is placed over the stage 314 travels through the illumination optics 312 and falls onto the workpiece 313. The magnifying optics 315 and sensor module 316 are disposed below workpiece 313 for guiding the transmission light that passed through workpiece 313, such as a photomask for the exposure use, to be focused via magnifier optics 315 on the photosensitive surface of the sensor in sensor module 316. Magnifier optics 315 may be subjected to auto-focus adjustment by an automatic focusing mechanism (not shown).

The stage 314 is controlled by the stage control circuit 303 that is operatively responsive to receipt of a command from the host computer 301, and is movable in X and/or Y direction(s) with or without rotation by angle θ upon activation of the driver 308. An example of driver 308 is a three-axis (X-Y-θ) motor assembly, including an X-motor, Y-motor and θ-motor, which may be stepper motors.

The sensor module 316 may employ a charge-coupled device (CCD) sensor, such as a time-delay integration (TDI) sensor or else. This TDI sensor picks up or “capture” the pattern of workpiece 313 while the stage 314 is driven to move continuously in the X-direction. The image sensed is converted to an electrical signal indicative of measured pattern data (i.e., tested-pattern image data), which is then sent to the comparator circuit 307. The measured pattern data may typically be a string of 8-bit unsigned data, which represents the grayscale gradation or “tone” of the brightness of a respective picture element—i.e., pixel.

Meanwhile, access is given to the database of mask design data being presently stored in the data memory 304 to create therefrom an “ideal” mask pattern image at the data expander circuit 305 and reference data generator circuit 306. This information is then transferred to the comparator circuit 307.

The comparator 307 is responsive to receipt of the test-use fiducial pattern image as produced by the data expander 305 and reference data generator circuit 306 and also the to-be-tested pattern image generated at the sensor module 316 with respect to the transmission image obtained from the workpiece 313, for comparing, after having corrected the fiducial pattern image, these images together in accordance with a plurality of algorithms, thereby determining whether defects are present or absent.

It is noted that the stage controller 303 and data expander 305 along with the reference data generator circuit 306 and comparator circuit 307 which make up the computation control unit are configurable from electrical circuitry or may be arranged by software programs executable by the host computer 301 or, alternatively, any possible combinations thereof.

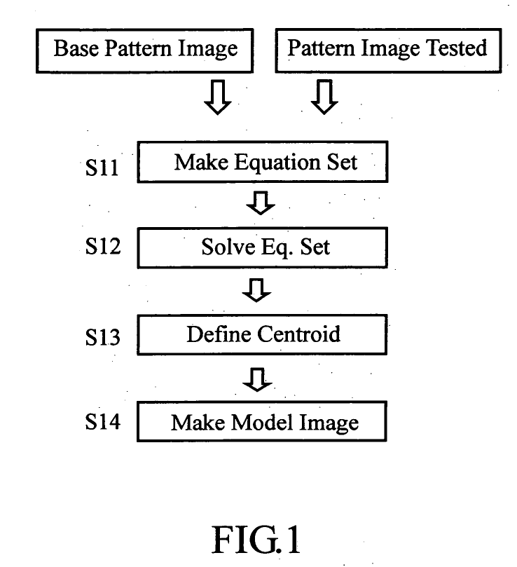

Described below is a method for correcting or ameliorating the inspection fiducial pattern image by using the above-stated apparatus to thereby generate a new version of fiducial pattern image with respect to the pattern image to be tested. A process flow diagram of this method is shown in FIG. 1.

Preferably, prior to entering this process shown in FIG. 1, pre-processing is performed in such a way as to find a specific position which is minimal in evaluation function represented by a square sum of differences in gradation between respective corresponding pixels of the both images. If such evaluation function-minimized position is found then perform position shifting in units of pixels to thereby correct a pixel position misalignment so that it decreases to a degree less than one pixel size.

As shown in FIG. 1, the embodiment method starts with step S11 of generating a system of simultaneous equations. At this step S11, first receive data items indicative of an inspection fiducial pattern image and to-be-tested pattern image. While regarding the former as two-dimensional (2D) input data and letting the latter be 2D output data, set up a 2D input/output linear prediction model. A procedure for doing this will be discussed below while exemplifying a 5×5-dimension 2D linear prediction model using a region of a matrix of five rows and five columns of pixels.

TABLE 1

| | 0 | 1 | 2 | 3 | 4 |
|---|---|---|---|---|---|
| 0 | i − 2, j − 2 | i − 2, j − 1 | i − 2, j | i − 2, j + 1 | i − 2, j + 2 |
| 1 | i − 1, j − 2 | i − 1, j − 1 | i − 1, j | i − 1, j + 1 | i − 1, j + 2 |
| 2 | i, j − 2 | i, j − 1 | i, j | i, j + 1 | i, j + 2 |
| 3 | i + 1, j − 2 | i + 1, j − 1 | i + 1, j | i + 1, j + 1 | i + 1, j + 2 |
| 4 | i + 2, j − 2 | i + 2, j − 1 | i + 2, j | i + 2, j + 1 | i + 2, j + 2 |

Let the 2D input data be represented by u(i,j), and let the 2D output data be y(i,j). The suffix of a pixel of interest is given as “i,j.” Define the suffix of a total of twenty five pixels which surround this pixel, including two precedent rows and two subsequent rows plus two pre-columns and two post-columns, in a way as indicated in Table 1.

Regarding the pixel data of a region having one set of five-by-five (5×5) pixels, establish a relational equation (1) below, in connection with a variable “y” which is 2D output data and a variable “u” that is 2D input data.

$$\begin{matrix}{y}_{k} = y ( i , j ) \\ = {b}_{00} u ( i - 2 , j - 2 ) + {b}_{01} u ( i - 2 , j - 1 ) + {b}_{02} u ( i - 2 , j ) + \\ {b}_{03} u ( i - 2 , j + 1 ) + {b}_{04} u ( i - 2 , j + 2 ) + \\ {b}_{10} u ( i - 1 , j - 2 ) + {b}_{11} u ( i - 1 , j - 1 ) + {b}_{12} u ( i - 1 , j ) + \\ {b}_{13} u ( i - 1 , j + 1 ) + {b}_{14} u ( i - 1 , j + 2 ) + \\ {b}_{20} u ( i , j - 2 ) + {b}_{21} u ( i , j - 1 ) + {b}_{22} u ( i , j ) + {b}_{23} u ( i , j + 1 ) + \\ {b}_{24} u ( i , j + 2 ) + \\ {b}_{30} u ( i + 1 , j - 2 ) + {b}_{31} u ( i + 1 , j - 1 ) + {b}_{32} u ( i + 1 , j ) + \\ {b}_{33} u ( i + 1 , j + 1 ) + {b}_{34} u ( i + 1 , j + 2 ) \\ {b}_{40} u ( i + 2 , j - 2 ) + {b}_{41} u ( i + 2 , j - 1 ) + {b}_{42} u ( i + 2 , j ) + \\ {b}_{43} u ( i + 2 , j + 1 ) + {b}_{44} u ( i + 2 , j + 2 ) + \\ ɛ ( i , j ) .\end{matrix} \qquad ( 1 )$$

In Equation (1), “b₀₀” to “b₄₄” are the model parameters to be identified, and ε(i,j) is a noise component.

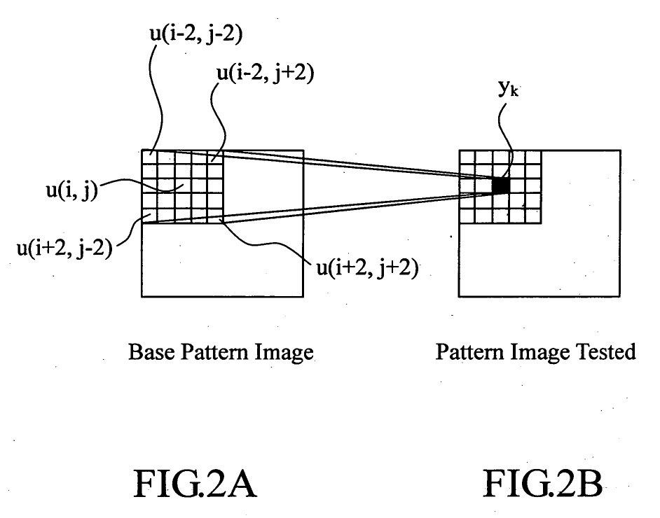

Equation (1) suggests that the data yₖ=y(i,j) of a pixel in the to-be-tested pattern is representable by the linear coupling of data items of 5×5 pixels around one pixel of a corresponding fiducial pattern. This relationship will be described with reference to FIGS. 2A and 2B. First see FIG. 2B, which pictorially shows an area of 5×5 pixels in the to-be-tested pattern image. One pixel yₖ of them is given as the linear coupling of data items of those pixels u(i−2, j−2), . . . , u(i−2, j+2), . . . , u(i−1,j−2), . . . , u(i+2, j+2) as shown in FIG. 2A.

Subsequently the procedure of FIG. 1 goes next to step S12. This step S12 is to solve the system of equations as set at step S11 to thereby obtain a parameter “b”. This is called the model parameter identification.

More specifically, Equation (1) is vectorially reformulated as indicated below.

Unknown Parameter Vector: α=[b₀₀, b₀₁. . . , b₄₄]^{T} Data Vectors:
xₖ=[u(i−2, j−2), u(i−2, j−1), . . . , u(i+2, j+2)]^{T}xₖ^{T}α=yₖ (2)
Accordingly, identification of the model parameter b is achievable by jointing together twenty five sets of data through scanning of coordinates “i,j” of the fiducial pattern image and the to-be-tested pattern image.

In practical implementation, from a statistical viewpoint, a specified number n of data sets are prepared as in Equation (3), where n is an integer greater than twenty five, i.e., n>25. Then, identify a by solving 25-dimensional simultaneous equations based on a least-squares method in a way which follows.

$$[ \begin{matrix}{x}_{1}^{T} \\ ⋮ \\ {x}_{n}^{T}\end{matrix} ] α = [ \begin{matrix}{y}_{1} \\ ⋮ \\ {y}_{n}\end{matrix} ] ⇒ A α = y ⇒ α = {( {A}^{T} A )}^{- 1} {A}^{T} y \qquad ( 3 )$$

where, A=[x₁, x₂, . . . , xₙ]^{T}, y=[y₁, y₂, . . . , yₙ]^{T}, and xₖ ^{T}α=yₖ(k=1,2, . . . , n).

For instance, when each of the to-be-tested pattern image and the fiducial pattern image is of 512×512 pixels, the scanning of the 5×5-dimensional model results in outer peripheral portions of the image being reduced by two pixels respectively. Thus it is expected to obtain n sets of data, where n is given by Equation (4) below.
n=(512−4)×(512−4)=258,064. (4)
This encourages us to believe that a sufficient number of data sets are acquirable when looking at from statistical viewpoints.

Then, as shown in FIG. 1, the routine proceeds to step S13 for centroid calculation. In this process, calculate a weighted center, i.e. centroid, of the identified parameters b₀₀ to b₄₄ which are obtained from the set of the values of parameters b₀₀ to b₄₄ defined at the previous step. More precisely, in a given area of 5×5 pixels, obtain a centroid “u” in the x-direction and a centroid “v” in y-direction by Equations (5) and (6) presented below.

$$\begin{matrix}u = \frac{{\sum }_{ij} ( i - 2 ) {b}_{ij}}{{\sum }_{ij} {b}_{ij}} & ( 5 ) \\ v = \frac{{\sum }_{ij} ( j - 2 ) {b}_{ij}}{{\sum }_{ij} {b}_{ij}} & ( 6 )\end{matrix}$$

The centroid thus obtained indicates that a “true” centroid which should be placed exactly at the center of the 5×5 pixel area offsets and resides at a location other than the pixel area center. A displacement from the pixel area center is equivalent to a shift of the pattern.

Thereafter the routine of FIG. 1 goes to step S14 of model image generation. This process is to use the x-direction centroid u and y-direction centroid v obtained at the previous step to create a new version of fiducial pattern image.

In this step, linear coupling-based image correction is carried out while letting the shift amount in the x direction be “u”, letting the shift amount in the y direction be “v”, and representing a pixel of the fiducial pattern image be “zᵢ”. Computation for this correction is attainable by sequentially applying one-dimensional (1D) filtering in the x- and y-directions to the pixels zᵢ of the fiducial pattern image. Here, this may be done by bicubic interpolation methods as shown in Equations (7) and (8) below.

$$\begin{matrix}\begin{matrix}{z}_{i}^{′} = \frac{1}{2} {u}^{2} ( u - 1 ) {z}_{i + 2} + \frac{1}{2} u ( 1 + 4 u - 3 {u}^{2} ) {z}_{i + 1} + \\ \frac{1}{2} ( u - 1 ) ( 3 {u}^{2} - 2 u - 2 ) {z}_{i} - \frac{1}{2} {u ( u - 1 )}^{2} {z}_{i - 1}\end{matrix} & ( 7 ) \\ \begin{matrix}{z}_{j}^{″} = \frac{1}{2} {v}^{2} ( v - 1 ) {z}_{j + 2}^{′} + \frac{1}{2} v ( 1 + 4 v - 3 {v}^{2} ) {z}_{j + 1}^{′} + \\ \frac{1}{2} ( v - 1 ) ( 3 {v}^{2} - 2 v - 2 ) {z}_{j}^{′} - \frac{1}{2} {v ( v - 1 )}^{2} {z}_{j - 1}^{′}\end{matrix} & ( 8 )\end{matrix}$$

In this embodiment, the accuracy of the fitting may become higher in the case of direct creation of a model image according to Equation(1) without having to obtain the above-stated centroid. However, the computation of this embodiment may exhibit appreciable effects in case of application to comparison algorithms with non-negligible influenceabilities of a change in total light intensity due to image correction, such as for example detection of pattern line-width defects. This can be said because the embodiment computation has its nature that a total light amount of the image is saved.

Although the above-noted embodiment is under an assumption that the coefficient of a filter is calculated, once at a time, whenever required in Equations (7) and (8), this filter calculation may be executed at high speeds by arranging it so that those filter coefficients corresponding to different parameters u and v are computed in advance and prestored in a storage device in a look-up table form.

### Second Embodiment

A second embodiment of the invention is drawn to a pattern inspection method employing the image correction method of the first embodiment stated supra. More specifically, execution of a sequence of the process steps S11 to S14 of FIG. 1 results in creation of a new version of inspection fiducial pattern image with its image shifts being accurately corrected. This new fiducial pattern image is then compared to a pattern image to be tested, thereby enabling inspection of defects in the circuit pattern formed on a workpiece.

A technique used in this process may be any one of currently established schemes which employ algorithms for inspection of coincidence between a couple of arbitrary images. An example of such algorithms is a level comparison algorithm which specifies at every portion a difference in gradation between a fiducial pattern and a to-be-tested pattern and, if a portion with its gradation difference being in excess of a predefined value is found, then determines it as a defect.

### Third Embodiment

A third embodiment of the invention relates to a defect inspection method adaptable for use in the case of testing a photomask pattern by using both of a pattern obtained by transmission light and a pattern obtained by reflection light. Although a mask defect inspection apparatus employable in this embodiment will be described below, repetitive explanations are eliminated as for the same process and system configuration as those of the first and second embodiments stated supra.

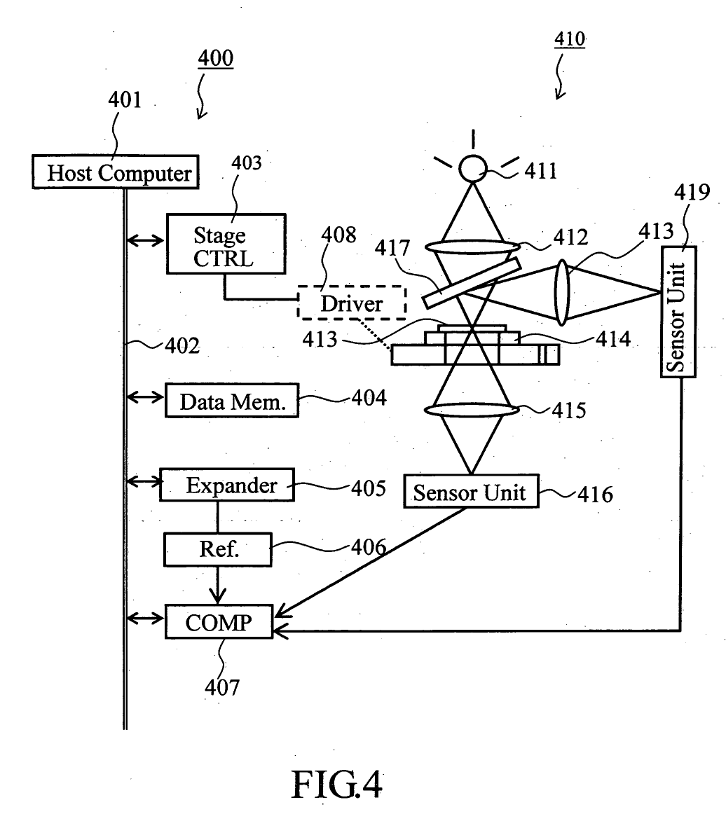

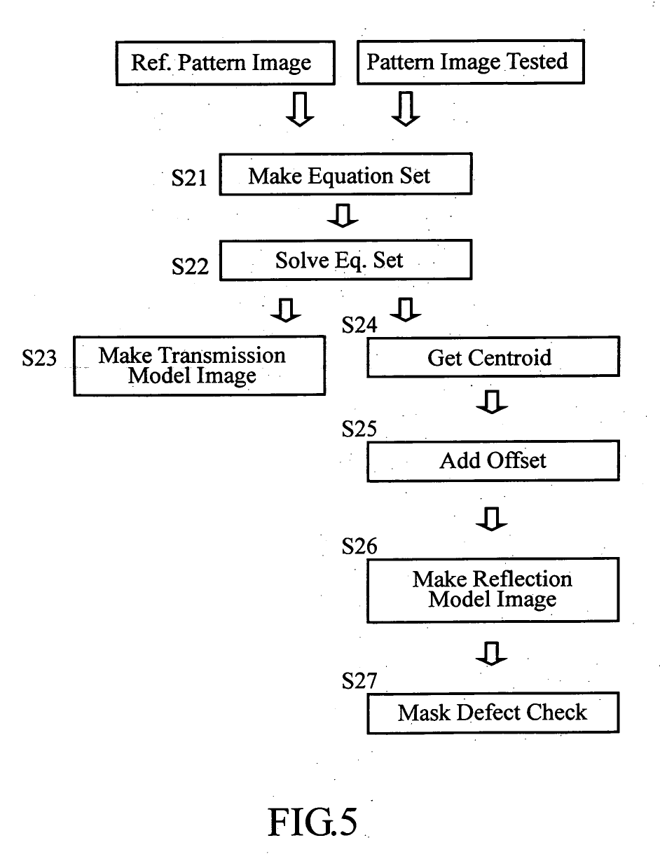

See FIG. 4, which depicts a configuration of main part of the mask defect inspection apparatus adaptable for use in this embodiment. The illustrative apparatus is generally made up of an arithmetic computation control unit 400 including a host computer as its main component, and an observational data generator unit 410 which operates to pick up the pattern image of a workpiece being tested, e.g., a photomask.

The main controller 400 includes a host computer 401, a signal transfer path 402 having address and data buses connected thereto, a stage control circuit 403 coupled to this signal path 402, a data storage memory 404, a data expander circuit 405, a referencing or reference data generator circuit 406, and a comparison circuit 407.

The observation data generator 410 is configured from a light source 411, an illumination optical system 412 which collects together rays of light as emitted from the light source 411 and forces the collected light to fall onto a workpiece 413 that is mounted on a stage structure 414, a first magnifying optical lens assembly 415 which forms an optical pattern image of incoming transmission light that passed through the workpiece 413, and a first sensor module 416 which has a photosensor for capturing the optical pattern image of the workpiece and a driver/signal-processor circuit associated therewith. A beam splitter 417 is settled between the illumination optics 412 and workpiece 413 whereby reflection light of the light falling onto workpiece 413 is reflected by this beam splitter 417 and then travels through a second magnifier lens assembly 418 to be focused on the photosensitive surface of a sensor as built in a second sensor module 419.

The stage 414 is driven by a drive unit 408 connected thereto. This driver 408 is controlled in operation by the stage controller 403 stated previously.

The comparator circuit 407 is responsive to receipt of fiducial pattern data as generated by the data expander circuit 405 and reference data generator circuit 406 along with measurement pattern data with respect to each of transmission and reflection light images, for applying image correction thereto and for comparing them together in accordance with a plurality of algorithms to thereby detect defects, if any.

An operation of the mask defect inspection apparatus of FIG. 4 is as follows. The workpiece 413—here, a photomask for the exposure use—is automatically conveyed and loaded by an auto-loader mechanism (not shown) and then mounted on the stage 414. After completion of inspection, the exposure mask 413 is unloaded automatically. Light rays as emitted from the light source 411 overlying the stage 414 are guided by the illumination optics 412 to hit the mask 413 being tested. The first magnifier optics 415 and first sensor unit 416 are disposed to underlie mask 413. Transmission light that passed through mask 413 travels via magnifier optics 415 to be focused onto the photosensitive surface of the sensor in sensor unit 416.

Alternatively the light that hits the surface of mask 413 is reflected therefrom to enter the beam splitter 417 between the optics 412 and mask 413, resulting in the light progressing via the second magnifier optics 418 to reach the photosensitive surface of the sensor in second sensor unit 419 in the form of a focused light beam. Thus, data of the reflected light image from mask 413 is created. The first and second magnifier optics 415 and 418 may be under auto-focus adjustment by an auto-focusing mechanism (not shown).

The stage 414 is motion-controlled by the stage controller 403 which is operable in responding to receipt of a command(s) from the host computer 401, and is driven by the driver system 408 having a three-axis (X-Y-θ) motor module including X-, Y- and θ-motors so that stage 414 is slidable in X- and Y-directions with or without rotation at angle θ. These X-, Y- and θ-motors may typically be stepper motors.

The first and second sensor units 416 and 419 are each designed to include a TDI sensor as built therein. While letting the stage 414 move continuously in X-axis direction, the TDI sensor captures the pattern of workpiece 414 on stage 414. Resultant captured image data is sent as measured pattern data (to-be-tested pattern image data) toward the comparator circuit 407. The measured pattern data may be 8-bit unsigned data indicative of the grayscale gradation of the brightness of each pixel.

A mask pattern image is created by the data expander circuit 405 and reference data generator 406 from the database of mask design data or else being stored in the data memory 404. This information is passed to comparator circuit 407.

Upon receipt of the fiducial pattern image that was generated by the data expander 405 and reference data generator circuit 406 and the to-be-tested pattern image from first sensor unit 416 with respect to the transmission image of the workpiece 413, the comparator circuit 407 makes a correction of the fiducial pattern image and then performs comparison in accordance with a plurality of algorithms, thereby determining whether defects are present or absent.

Note here that some of the components of the computation controller 400—namely, the stage controller 403, data expander 405, reference data generator 406 and comparator 407—are configurable from electrical circuitry or may alternatively-be implemented by software programs executable by the host computer 401.

Turning to FIG. 5, a method for correcting the fiducial test pattern image to generate a new version of fiducial pattern image with respect to the to-be-tested pattern image is shown in block diagram form.

Preferably, prior to entering this process shown in FIG. 5, pre-processing is performed in such a way as to find a specific position which is minimal in evaluation function represented by a square sum of differences in gradation between respective corresponding pixels of the both images. If such evaluation function-minimized position is found then perform position shifting in units of pixels to thereby correct a pixel position misalignment so that it decreases to a degree less than one pixel size.

The method of FIG. 5 starts with step S21 of defining a collection of equations with respect to the transmission image of a workpiece being tested. More specifically, generate a system of equations for 2D linear prediction relative to transmission image. This step is similar in simultaneous equation creation scheme to that of the previous embodiment shown at step S11 in FIG. 1.

Then, the procedure goes to step S22, which solves the simultaneous equations generated at the previous step, thereby calculating an identification parameter α of the transmission image. This step S22 is also designable to employ the scheme as has been discussed in conjunction with the step S12 in the first embodiment.

Next, at step S23, substitute the parameter α thus identified and the input/output image data used for the identification into Equation (1). Then, perform simulation computation for scanning pixel coordinates “i,j,” thereby producing a model image of the transmission image. This model image is the aimed correction image. Owing to execution of fitting based on least-squares techniques, this corrected image is reduced or minimized in less-than-one-pixel displacement, expansion/shrink and swell or “waving” noises, resizing noises and sensing noises. Although the data used for the simulation can contain therein defective pixels, these are negligibly less in number than overall data items used for the identification and thus are out of the least square method-based fitting, so no defective pixels appear in the model image. Another advantage lies in an increase in signal-to-noise (S/N) ratio of surrounding area, resulting defective pixels being visually emphasized.

At step S24, use the identification parameter α of the transmission image to calculate a centroid thereof.

In this process also, the technique used at step S13 of the first embodiment shown in FIG. 1 is employable.

After having defined the centroid, the system procedure goes to step S25, which adds an offset thereto. Generally it is difficult to ensure that the transmission image and reflection image are completely free from displacement therebetween even when the same workpiece is observed. Such displacement, i.e. position offset, is intrinsic or “unique” to the individual mask inspection apparatus and is measurable in advance.

This offset is measured in a way which follows. Capture the image of a test pattern by both the transmission light-sensitive sensor and the reflection light-sensitive sensor at a time. Then, based on the images thus obtained, measure an offset in position between these captured images.

Next, add to the centroid value obtained in the previous step a value indicative of the “known” offset between the transmission and reflection image sensors to provide an offset-added centroid value, which is for use as the shift amount of the reflection image.

Then go to step S26, which performs linear coupling intetpolation based on the shift amount obtained at the previous step S25 to thereby correct the reflection image. In this step the above-stated technique used at the step S14 of FIG. 1 is employable.

Thereafter, at step S27, compare together the transmission image and reflection image based on the data obtained heretofore, thereby to inspect the mask for defects. The comparison at this step is executable while regarding the fiducial pattern image developed from the image database as a fiducial image and letting either the transmission image or the reflection image be a to-be-tested image, although the invention should not exclusively be limited thereto.

Although in the above embodiment one specific example is shown which obtains a shift amount from the pattern's transmission image and uses it to perform position correction of the reflection image, the transmission and reflection images are replaceable with each other. In other words, similar results are also attainable by finding a shift amount from the reflection image, and then applying position correction to the transmission image.

While in the embodiments above assume the use of die-to-database techniques for comparison between sensed image data and design data, other approaches are also employable. One example is to use die-to-die schemes for comparing a couple of sensed image data together. Another example is to use the both types of schemes in combination.

While the present invention has been described with reference to specific embodiments, the description is illustrative of this invention and is not to be construed as limiting the invention. Various modifications and applications may occur to those skilled in the art without departing from the true spirit and scope of the invention as defined by the appended claims.

What is claimed is:

1. An image correction method for use in a pattern inspection method including emitting light falling onto a workpiece with a pattern formed thereon and inspecting a pattern image resulting from pickup of an optical image of the workpiece by comparing the pattern image to a corresponding inspection fiducial pattern image, said image correction method comprising:
generating a set of equations describing therein an input/output relation using a two-dimensional (“2D”) linear prediction model with respect to the pattern image being tested and the fiducial pattern image;
estimating the equation set describing the input/output relation by a least-squares method to thereby obtain a parameter of said equation set;
obtaining a centroid position of the parameter; and
performing interpolation using a value of said centroid position to thereby generate a corrected image.

2. An image correction method adapted to be used in a pattern inspection method for emitting light falling onto a workpiece with a pattern formed thereon and for performing inspection by comparing test pattern images resulted from pickup of respective optical images of transmission light and reflection light of the workpiece to an inspection fiducial pattern image corresponding thereto, said image correction method comprising:
generating a system of equations describing therein an input/output relation using a 2D linear prediction model with respect to any one of the test pattern images based on the transmission light and the reflection light and its corresponding inspection fiducial pattern image;
estimating by a least-squares technique the equation system describing the input/output relation to thereby obtain more than one parameter of said equation system;
using the parameter to combine together an estimation model image and said any one of the test pattern images;
obtaining a centroid of said parameter;
adding to said centroid a predefined offset value to thereby provide an added centroid position value; and
using said added centroid position value to apply interpolation to a remaining one of said test pattern images which is out of the 2D linear prediction, thereby generating a corrected image.

3. A pattern inspection method for emitting light falling onto a workpiece with a pattern formed thereon and for inspecting a pattern image resulting from pickup of an optical image of the workpiece by comparing the pattern image to a corresponding inspection fiducial pattern image, said method comprising:
generating a collection of equations describing therein an input/output relation using a 2D linear prediction model with respect to the pattern image being tested and the fiducial pattern image;
estimating the equations describing the input/output relation by a least-squares technique to thereby obtain more than one parameter of said equations;
obtaining a centroid position of the parameter;
performing interpolation using a value of the centroid position to thereby generate a corrected image; and
comparing the corrected image to said fiducial pattern image.

4. A pattern inspection method for emitting light falling onto a workpiece with a pattern formed thereon and for performing inspection by comparing test pattern images resulted from pickup of respective optical images of transmission light and reflection light of the workpiece to a corresponding inspection fiducial pattern image, said method comprising:
generating simultaneous equations describing therein an input/output relation using a 2D linear prediction model with respect to any one of the test pattern images due to the transmission light and the reflection light and its corresponding inspection fiducial pattern image;
estimating by a least-squares method the simultaneous equations describing the input/output relation to thereby obtain more than one parameter of the equations;
using the parameter to combine together an estimation model image and said any one of the test pattern images;
obtaining a centroid of said parameter;
adding to said centroid a prespecified offset value to thereby provide an added centroid position value;
using the added centroid position value to apply interpolation to a remaining one of said test pattern images which is free from the 2D linear prediction; and
comparing said corrected image to said fiducial pattern image.

5. The method according to claim 3, wherein said method is for inspecting defects of a lithography mask as used for fabrication of one of a semiconductor device and a liquid crystal display (LCD) device.

6. The method according to claim 3, wherein any two pixels are inspected for coincidence thereof in such a way as to determine presence of a defect when a difference in gradation between respective fiducial and test pattern pixels is greater than a predefined value.

7. The method according to claim 3, wherein inspection is done by using both a pattern obtained by transmitted light of a mask and a pattern obtained by reflection light of the mask.

8. A pattern inspection apparatus for emitting light falling onto a workpiece with a pattern formed thereon and for performing pattern comparison inspection by use of a pattern image to be tested resulting from pickup of an optical image of the workpiece and an inspection fiducial pattern image corresponding thereto, said apparatus comprising:
first means for generating a set of simultaneous equations describing therein an input/output relation using a 2D linear prediction model with respect to the pattern image being tested and the fiducial pattern image;
second means for estimating the equations describing the input/output relation by a least-squares technique to thereby obtain a parameter of said equations;
third means for obtaining a centroid position of the parameter;
fourth means for performing interpolation using a value of the centroid position to thereby generate a corrected image; and
fifth means for comparing the corrected image to said fiducial pattern image.

9. The apparatus according to claim 8, further comprising:
an illumination optical unit operative to irradiate light from a light source onto the workpiece;
a photosensor;
a magnification optical unit operative to focus output light of said illumination optical unit onto said photosensor;
a conversion device operative to convert an optical signal as detected by said photosensor into an electrical signal; and
a processor device for processing the electrical signal as output from said conversion device.

10. The apparatus according to claim 9, further comprising:
an auto-focus mechanism for performing automatic focusing of said magnification optical unit.

11. The apparatus according to claim 9, wherein said photosensor includes a time delay integration (TDI) sensor.

12. The apparatus according to claim 8, further comprising:
a first optical sensor for detection of reflected light from the mask;
a second optical sensor for detection of transmitted light from the mask; and
the first and second sensors generating signals as used to inspect the workpiece for defects.
